(19) United States
(12) Patent Application Publication
(10) Pub. No.: US 2022/0133588 A1
(43) Pub. Date: May 5, 2022

(54) HOT TUB WITH VARIED WATER LEVELS

(71) Applicant: Jason LeMay, Newton, NH (US)

(72) Inventor: Jason LeMay, Newton, NH (US)

(21) Appl. No.: 17/515,999

(22) Filed: Nov. 1, 2021

Related U.S. Application Data
(60) Provisional application No. 63/107,682, filed on Oct. 30, 2020.

(51) Int. Cl. A61H 33/00

(52) U.S. Cl. CPC A61H 33/0095; A61H 33/6089; A61H 2201/164; A61H 2205/081; A61H 2201/5051; A61H 2203/0431; A61H 2201/1633

(57) ABSTRACT

Hot tubs are disclosed herein that include a rigid outer shell having at least two seats formed therein and a footbed below the at least two seats. The at least two seats are either positioned equidistantly from the footbed or at unequal distances from the footbed. The hot tub includes at least two pumps and each pump is configured to pump water to a single seat. The hot tub has an equal number of seats and pumps as well as a skimmer positioned on a sidewall of the rigid shell. The skimmer extends at least one foot in a vertical direction and is configured to supply water to the pumps when a water level in the hot tub is as low as sixteen (16) inches from the footbed and when the water level in the hot tub is at least thirty (30) inches from the footbed.

### RELATED APPLICATION

This application claims the benefit of and priority to U.S. Provisional Patent Application Ser. No. 63/107,682, filed Oct. 30, 2020, the entire contents of which are herein incorporated by reference.

### FIELD OF THE INVENTION

The presently disclosed hot tub makes no compromises; it can be run at standard levels, very low levels and anywhere in between.

### BACKGROUND

Current hot tub and spa designs include a rigid shell over a frame structure. Pumps, tubing, and machinery for the hot tub or spa are generally contained in areas of the frame to support full levels of water in which the user's chest is fully or almost fully submerged. Furthermore, typical seat positions within a hot tub are arranged such that all included seats position the user with torso and sometimes part of the chest under the water line of the hot tub.

SUMMARY Hot tub or spa devices having low water levels and/or varied seating positions are disclosed herein. In some embodiments, the disclosed devices include at least one seat configured to position a user's torso above the water line. In select embodiments, the disclosed devices may also include at least one seat configured to position a user's torso at least partially underwater. The disclosed devices may, in some embodiments, include fountain or water outlet features configured to provide a stream of water above one or more of the user's shoulders when the user is seated in the hot tub.

As explained in detail below, the presently disclosed hot tubs are configured to accommodate high or low water levels. In some embodiments, the seats of the disclosed hot tubs may appear in normal positions relative to one another, but in other embodiments, the seats within a single hot tub may be positioned higher or lower than one another (such as in a hybrid model) to allow users to rest in different positions relative to the water level in the hot tub.

The disclosed hot tubs can provide significant benefits over conventional hot tubs. For example, up to 60% less water may be needed to fill hot tubs as presently disclosed herein. Additionally, the disclosed hot tubs may provide a reduction in heating costs for the water supply and/or reduced chemical maintenance for the water contained within the hot tub. Numerous other benefits may also be possible with the disclosed hot tub devices and are discussed in detail below.

### BRIEF DESCRIPTION OF THE DRAWINGS

FIG. 1 shows a perspective view of an exemplary hot tub having varied seating positions, in accordance with some embodiments of the present disclosure.

FIG. 2 shows a cross-sectional view of the exemplary hot tub of FIG. 1, in accordance with some embodiments of the present disclosure.

FIG. 3 shows a perspective view of an exemplary hot tub configured to maintain a low water level, in accordance with some embodiments of the present disclosure.

FIG. 4 shows a cross-sectional view of the exemplary hot tub of FIG. 3, in accordance with some embodiments of the present disclosure.

It should be appreciated that the included figures do not illustrate all possible features of the presently disclosed hot tub devices and that other configurations and variations are possible and contemplated herein.

### DETAILED DESCRIPTION

Hot tubs, spas, whirlpool tubs, or other water-containing systems are provided herein. In particular, various type of water-containing vessels (referred to generally as “hot tubs” herein for simplicity) are configured to run at varying water levels. In some embodiments, the seats of the hot tub are equally or approximately equally positioned relative to the water line, whereas in other embodiments the hot tub includes seating positions that are varied relative to the water line.

Hot tubs, including jetted hot tubs, are generally configured to position all users in a seated position with the torso and/or chest area under the water contained in the hot tub. Although this position is desirable for some users, it may not be preferred in all cases. For example, if a user wishes to keep his/her arms, chest, and/or torso dry or cool, an elevated seating position relative to the water level may be preferable. Additionally, a pregnant user may not be able to use a hot tub unless the torso remains above water. In such cases, having a hot tub with various seating positions available (or that can accommodate varying water levels) may provide useful functionality that is not possible with conventional hot tubs.

It should be appreciated that the disclosed herein may be used in connection with any suitable water-containing device, including but not limited to jetted or non-jetted hot tubs, swim spas, and (indoor or outdoor) whirlpool tubs. For ease of description, the described devices and techniques are generally discussed with respect to use in a “hot tub” although it is to be understood that the present disclosure is not intended to be so limited.

The disclosed hot tub devices include at least one seat configured to position part of a user's body above the water line of the hot tub (e.g., all of the user's body above the waist), either by lowering the entire water level of the hot tub or elevating one or more seats of the hot tub relative to the water level. If water outlet features are present, the user may choose to activate the water outlet feature for their chosen seat and allow water from the hot tub to flow out from openings positioned above the water line (e.g., above the user's shoulders) such that water flows onto the user's shoulders and/or chest. When activated, the water outlet features may provide warmth and/or therapeutic effects for the user. The hot tub may also include a plurality of back jets for the user seated in an elevated position relative to the water line, if desired.

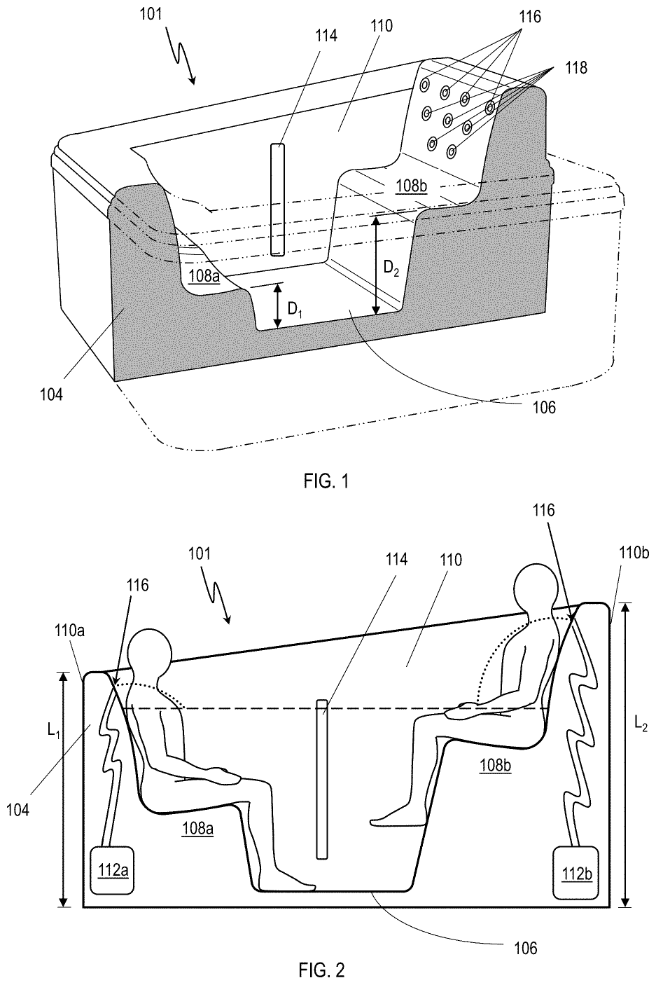

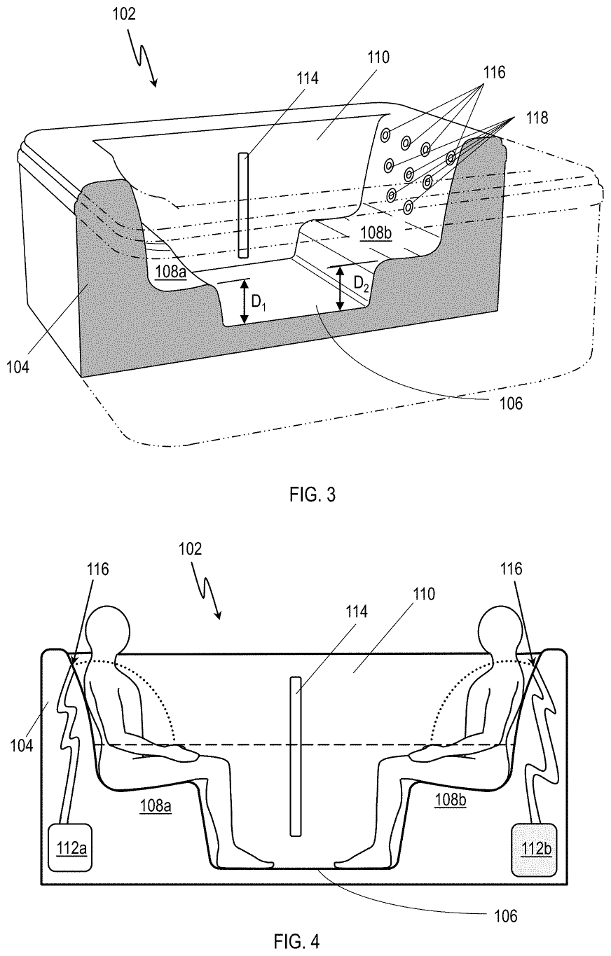

The disclosed hot tubs may, in some embodiments, have all included seats configured to elevate a user's torso above the water line (i.e., a ‘standard model’). To the eye, a standard model may appear just as a conventional hot tub, but with a lower water level. However, various plumbing and pumping mechanisms may be included under the shell of the hot tub to permit water to flow to the features positioned above the water line of the device. In other embodiments, however, the disclosed hot tubs may include both elevated and conventional seating positions (i.e., a ‘hybrid model’). FIGS. 1 and 2 illustrate and example hybrid model hot tub and FIGS. 3 and 4 illustrate an example standard model hot tub. In particular, FIG. 1 shows a perspective view of a hybrid configuration in which one seat is configured to position a user with its torso in the water and another seat is configured to position a user with its torso above the water. The dotted lines in FIG. 2 illustrate water outlet features that provide a stream of water over the shoulders of the users seated in the hot tub. The water outlets, if present, may be positioned below a headrest and/or over the user's shoulders to allow water to flow over the user's chest.

FIGS. 3 and 4 illustrate an exemplary standard model hot tub configured to run on very low water levels (e.g., 20 inches or less from the footbed). Specifically, as shown in FIG. 4, the water level is at the waistline of the users, but the pumps and returns are positioned to allow water to flow over the shoulders of the users.

FIG. 1 shows a perspective view of an exemplary hybrid model hot tub 101 and FIG. 2 shows a cross-sectional view of the hot tub 101 shown in FIG. 1. FIG. 3 shows a perspective view of an exemplary standard model hot tub 102 and FIG. 4 shows a cross-sectional view of the hot tub 102 shown in FIG. 3. Various features of the hot tubs 101, 102 will now be discussed in detail.

FIGS. 1 and 2 illustrate an exemplary hybrid model hot tub 101 having a rigid outer shell 104. As shown in FIGS. 1 and 2, the rigid outer shell 104 includes a footbed 106 and at least two seats (108a, 108b). As shown in FIG. 1, D₁ is the distance from footbed 106 to seat 108a, and D₂ is the distance from footbed 106 to seat 108b. In the hybrid model hot tub 101, D₁ and D₂ are not equal. In some embodiments, D₁ and D₂ may have a difference of at least six inches, 8 inches, 10 inches, 12 inches or more. In some cases, D₁ may be 12 inches, 14 inches, 16, inches, 18 inches, 20 inches, 22 inches, or 24 inches and/or D₂ may be 24 inches, 26 inches, 28 inches, 30 inches, 32 inches, 34 inches, or 36 inches.

The exemplary standard model hot tub 102 illustrated in FIGS. 3 and 4 also includes a rigid outer shell 104 having a footbed 106 and at least two seats (108a, 108b) formed therein. As shown in FIG. 3, D₁ is the distance from footbed 106 to seat 108a, and D₂ is the distance from footbed 106 to seat 108b. In the standard model hot tub 102, D₁ and D₂ are equal or approximately equal. For example, in some embodiments, D₁ and D₂ may be 20 inches, 22 inches, 24 inches, 26 inches, 28 inches, or 30 inches. Although not shown in FIGS. 1-4, the rigid outer shell 104 of hot tub 101 or 102 may include additional seats, such as three, four, five, six, or more seats, in some embodiments.

The disclosed hot tubs may have any desired dimensions. For example, a standard model hot tub 102 may have sidewalls 110 that are all equal in length. In some such embodiments, the sidewalls 110 of hot tub 102 may have a length of 36 inches to 48 inches. A hybrid model hot tub 101 as described herein may have sidewalls 110 of unequal lengths. For example, as shown in FIG. 2, hot tub 101 may have a first sidewall 110a having a length (L₁) and a second sidewall 110b having a length (L₂) that is unequal to L_{1.} In some embodiments, L₁ may be approximately 36 inches and L₂ may be approximately 48 inches, however, other dimensions are also possible and contemplated herein.

As will be appreciated by those skilled in the art upon consideration of the subject disclosure, some benefits of the presently disclosed hybrid models may include, but are not limited to, better visibility of the area surrounding the hot tub for the user sitting in the elevated seat, which may be particularly helpful for shorter users or children. A hybrid model may also be able to use a non-tapered cover, which can have better insulation properties. The disclosed hybrid model may also present a unique profile, which may be appealing to some users.

Standard hot tubs have one or two pumps that supply water to all of the seats in the hot tub with one or two sets of controls to turn jets in the seats on and off. If the user decided to run a conventional hot tub at a lower water level this would expose the jets and cause water to spray across the hot tub seat that is vacant. The presently disclosed hot tubs can have controls for each seat so that seats can be turned on and off individually. This can be accomplished with controls for every seat. For example, each seat may have its own pump with controls for it. In some embodiments, the controls may also include valves to turn seats on or off, or a combination of both. Numerous configurations and variations are possible and contemplated herein.

As shown in FIGS. 2 and 4, the disclosed hot tubs 101, 102 may include at least two pumps 112a, 112b to provide water to the seats 108a, 108b of the hot tub. Pumps 112a, 112b can be retained within the rigid housing 104. As shown in FIGS. 2 and 4, pump 112a is configured to provide water to seat 108a and pump 112b is configured to provide water to seat 108b. In embodiments in which there are more than two seats 108, there may also be more than two pumps 112. Specifically, hot tubs 101, 102 may include an equal number of seats 108 and pumps 112, with each pump 112 configured to provide water to a single seat 108.

All conventional hot tubs have a skimmer to draw water for the pumps from the water line. The skimmer draws in leaves and other debris to keep the hot tub water clean. The skimmer is normally fixed or only minimally able to adjust vertically. However, the disclosed hot tubs 101, 102 can include a long vertical track with a floating skimmer 114 that adjusts based on how much water is present in the hot tub, thus accommodating low water levels and high water levels alike. The floating skimmer can drop as the water level drops so water would continue to be drawn into the intake. As shown in FIGS. 1-4, the hot tub 101, 102 can include a skimmer 114 positioned on a sidewall of the rigid shell 104. The skimmer 114 can extend at least one foot in a vertical direction, in some embodiments. The skimmer 114 can be in fluid communication with all pumps 112 (e.g., 112a, 112b) of the hot tub 101, 102. Skimmer 114 can be configured to supply water to the pumps 112a, 112b, when a water level in the hot tub 101, 102 is as low as sixteen (16) inches from the footbed 106 and when the water level in the hot tub is at least thirty (30) inches from the footbed 106. In these and other embodiments, the skimmer can extend from 15 inches above the footbed to approximately 30 inches from the footbed.

In some embodiments, the standard model and/or hybrid model may include water outlets and/or large ports 116 positioned over the shoulder area of the user when seated. In select embodiments, each seat 108 may have separate controls for water outlets/ports 116. As shown in FIGS. 2 and 4, the water outlets/ports 116 may be in fluid communication with at least one pump 112. In some embodiments, the hot tubs (101 and/or 102) may include a mobile massage wand outfitted with a flexible hose and a water supply, similar to a massage-style shower head.

Current hot tubs do not include water ports to cover the entire upper body with water. Rather, in conventional hot tubs, the user is mostly under water because of the high water level. Having the hot tub water level lower gives the user the option of having the hot water flowing over their upper body or not. This feature can be very beneficial because it is very common to get overly hot while using a hot tub. In some embodiments, large low pressure ports 116 can be positioned to cover the upper body and arms for warmth and therapy. These ports 116 can be outfitted with valves to turn on and off as the user chooses. With the water level at waist level, the user could still have the back jets 118 on while the front of their torso is out of the water. If a user desired additional warmth, they could simply engage the “shoulder ports” 116 to provide waterflow to that region of the body. When the shoulder ports 116 are engaged, water is allowed to run over the shoulders and arms and the user effectively under water from the neck down.

The standard model hot tubs 102 may provide advantages over previous hot tub configurations. For example, the presently disclosed standard model hot tubs 102 may be able to keep water hotter for longer, if desired. Moreover, the standard model hot tubs 102 may provide greater water level flexibility for the user(s). Additionally, less water (e.g., up to 60% less water in some cases) may be needed to operate the standard model hot tubs 102 described herein. A reduction in required water can translate to up to 50% savings in heating costs, less water usage when changing the water, less chemical usage, faster water heating, as well as enabling user of a smaller water heater, if desired.

All configurations of the presently disclosed hot tubs provide other unique benefits. Specifically, the varied seating positions of the disclosed hot tubs can easily accommodate users of varied heights and sizes. The disclosed elevated seating positions can be useful as cool down seats for users, if desired. Since the disclosed hot tubs can be implemented with standard seat configurations and/or lounger seat configurations, numerous variations are possible for customization and comfort. Additionally, if preferred, each seat of the hot tub can include separate pumping equipment for increased energy efficiency.

### EXAMPLES

In some example embodiments, a hot tub configured in accordance with the subject disclosure may be constructed as follows. The hot tub may have at least two seats (for example two, three, four, five, six, or more seats). Each seat may have its own water pump positioned within the hot tub frame behind the seat that the pump controls. Thus, if there are two seats in the hot tub, the hot tub can include two pumps (one for each seat). Conventional tubs typically have one or two pumps and each pump supplies water to three or more seats. Having a separate pump for each hot tub seat is thus unique based on current and previous hot tub designs. Including a separate pump for each hot tub seat can provide benefits when the hot tub is run at low water levels. For example, having distinct pumps for each hot tub seat ensures that when a low water level is being used, only the occupied seats are actively supplied with water, thereby avoiding water being sprayed from unoccupied seats being actively supplied with pumped water.

In some such example embodiments, each pump can be controlled independently by electric controls. More specifically, each hot tub seat can be outfitted with proximate electrical controls to control the pump supplying water to the seat. Conventional hot tubs have only one or two controls for the entire hot tub, which can include five, six, or more seats. The currently described hot tubs can have two, three, four, fix, six, or more pumps, each with its own electric controls positioned so a user can comfortably reach the controls for the seat in which they are sitting.

To control water flow from the pumps, the disclosed hot tubs may include unique valving and port configurations. For example, in some embodiments, large diameter flood ports may be plumbed in for the shoulders (i.e., the ports may be positioned to supply water to a user's shoulders when a user is seated in a seat within the hot tub). Any desired dimensions and shapes may be used for the large diameter flood ports and, in some embodiments, the large diameter ports may have a dimension of at least one inch, two inches, three inches, four inches, or more.

In some embodiments, the out flow of the pumps can be directed to back jets for the seat(s) via a manifold and to low pressure “flood ports” over the shoulders. In some embodiments, there may be a separate valve at each seat to adjust the amount of flow to the flood ports. In these and other embodiments, there may also be a pressure adjustment for the back jets of the seat. As will be appreciated by those skilled in the relevant art, the presently disclosed hot tubs 101, 102 may also include a water intake positioned on a sidewall 110 within 15 inches of the footbed 106.

In some embodiments, the intake/skimmer may drop to as low as 15″ or 16″ from the bottom of the hot tub footbed 106. In some such embodiments, the hot tub can support a water level as low as 16-18″ or as high as 30″ or more. The skimmer door may float and stay with the water level, if desired. With a standard skimmer, as soon as the water is slightly below the designed level, the intake/skimmer would be out of the water and draw air into the pump, which disables the pump. In contrast with conventional intakes/skimmers, the presently disclosed vertical intake/skimmer 114 allow the hot tub to be run at both high a low water levels.

The features and advantages described herein are not all-inclusive and, in particular, many additional features and advantages will be apparent to one of ordinary skill in the art in view of the drawings, specification, and claims. Moreover, it should be noted that the language used in the specification has been selected principally for readability and instructional purposes, and not to limit the scope of the inventive subject matter described herein. The foregoing description of the embodiments of the disclosure has been presented for the purpose of illustration; it is not intended to be exhaustive or to limit the claims to the precise forms disclosed. Persons skilled in the relevant art can appreciate that many modifications and variations are possible in light of the above disclosure. What is claimed is:

1. A hot tub comprising:
a rigid outer shell having at least two seats formed therein and a footbed positioned below the at least two seats;
at least two pumps, wherein each pump is configured to pump water to a seat and there are an equal number of seats and pumps in the hot tub; and
a skimmer positioned on a sidewall of the rigid shell, the skimmer extending at least one foot in a vertical direction, wherein the skimmer is configured to supply water to the pumps when a water level in the hot tub is as low as sixteen (16) inches from the footbed and when the water level in the hot tub is at least thirty (30) inches from the footbed.

2. The hot tub of claim 1, wherein the hot tub has sidewalls that are all equal in length.

3. The hot tub of claim 2, wherein the sidewalls each have a length of between thirty six (36) to forty-eight (48) inches.

4. The hot tub of claim 2, wherein the at least two seats are positioned at an equal distance from the footbed.

5. The hot tub of claim 1, wherein the hot tub has at least two sidewalls that are unequal in length.

6. The hot tub of claim 5, wherein the hot tub has a first sidewall having a length of approximately thirty six (36) inches and a second sidewall having a length of approximately forty-eight (48) inches.

7. The hot tub of claim 5, wherein the at least two seats are positioned at different distances from the footbed.

8. The hot tub of claim 7, wherein a first seat is positioned at a first distance from the footbed and a second seat is positioned at a second distance from the footbed, and wherein the second distance is at least twelve inches greater than the first distance.

9. The hot tub of claim 1, wherein the hot tub has at least three seats and three pumps.

10. The hot tub of claim 1, wherein the hot tub has at least four seats and four pumps.

11. The hot tub of claim 1, wherein the hot tub has at least five seats and five pumps.

12. The hot tub of claim 1, wherein the hot tub has at least six seats and six pumps.

13. The hot tub of claim 1, wherein each pump is configured to provide water to a flood port for a single seat.

14. The hot tub of claim 1, wherein each seat further comprises back jets.
